(19) United States
(12) Patent Application Publication
(10) Pub. No.: US 2008/0084676 A1
(43) Pub. Date: Apr. 10, 2008

(54) Connector structure

(75) Inventor: Kuang-Hua Shiu, Jhongli City (TW)

Correspondence Address: Troxell Law Office Pllc, Suite 1404, 5205 Leesburg Pike, Falls Church, VA, 22041, US

(73) Assignee: Singatron Enterprise Co., Ltd.

(21) Appl. No.: 11/543,979

(22) Filed: Oct. 6, 2006

(51) Int. Cl. H01R 12/18

(52) U.S. Cl. 361/759

(57) ABSTRACT

A connector structure is constituted by a case, an elastic terminal, locking elements, and an external circuit board, wherein the case includes projection parts which are provided with through-holes, such that the connector can be latched with the external circuit board through the locking elements, thereby enabling the connector to be rigidly assembled with the external circuit board.

### BACKGROUND OF THE INVENTION

(a) Field of the Invention

The present invention relates to a connector structure, and more particularly to a connector structure, wherein side edges of a case are installed with projection parts which are provided with through-holes, such that the connector is locked with an external circuit board through locking elements.

(b) Description of the Prior Art

Referring to FIG. 1 and FIG. 2, a conventional connector A′ is composed of a case A1, an elastic terminal A2, projection parts A3, and an external circuit board A4, wherein the connector A is only latched with slots A5 of the external circuit board A4 in a sink-board style through the projection parts A3 of case A1, which is not easy to allow the connector A to be rigidly assembled with the external circuit board A4, and thereby resulting in a problem of getting loosened or dropped off.

Accordingly, how to eliminate the aforementioned problem is a technical issue to be solved by the present inventor.

### SUMMARY OF THE INVENTION

The primary object of present invention is to provide a connector structure, wherein side edges of a case are provided with projection parts having through-holes, such that the connector is latched with an external circuit board through locking elements, thereby enabling the connector to be rigidly assembled with the external circuit board.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional connector.

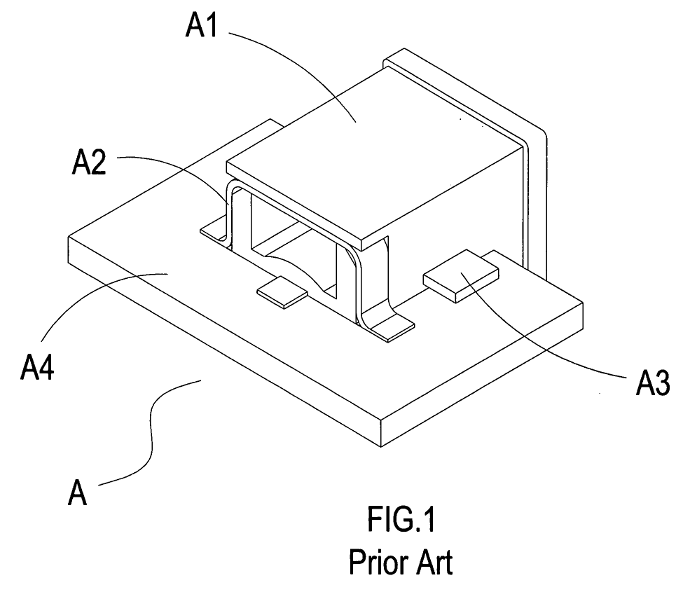

FIG. 2 shows an exploded view of a conventional connector.

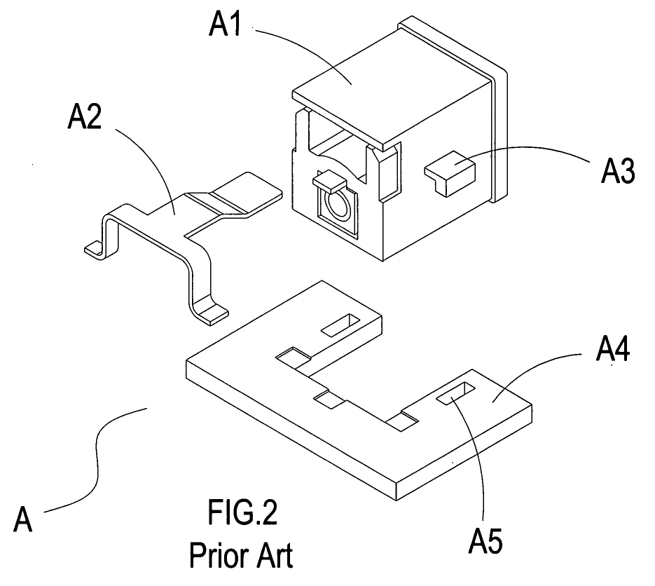

FIG. 3 shows a perspective view of the present invention.

FIG. 4 shows an exploded view of the present invention.

FIG. 5 shows a schematic view of an embodiment of the present invention.

FIG. 6 shows a second schematic view of an embodiment of the present invention.

FIG. 7 shows a third schematic view of an embodiment of the present invention.

FIG. 8 shows a fourth schematic view of an embodiment of the present invention.

FIG. 9 shows a fifth schematic view of an embodiment of the present invention.

### DETAILED DESCRIPTION OF THE PREFERRED EMBODIMENTS

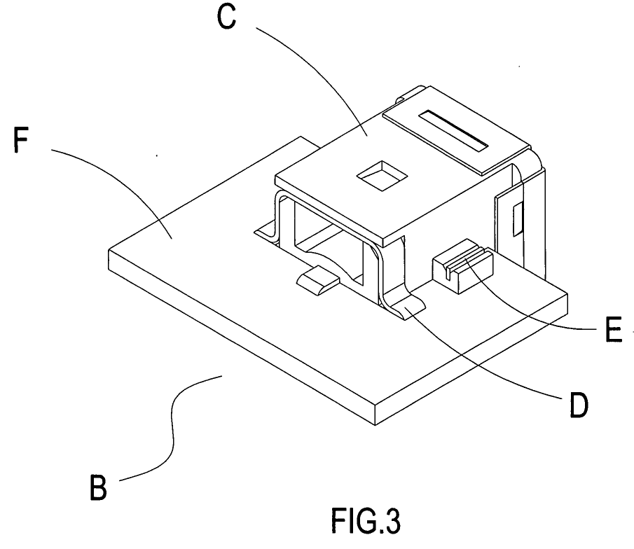

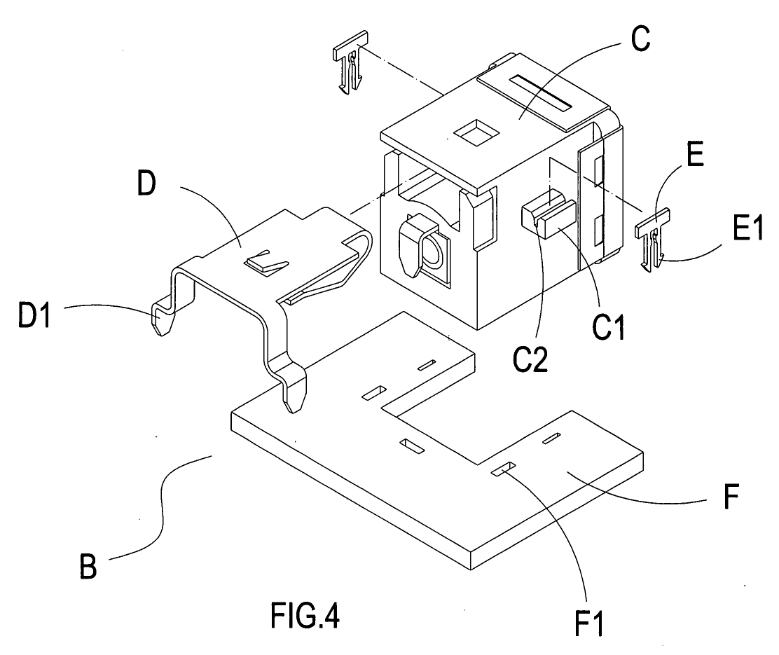

Referring to FIG. 3 and FIG. 4, a connector structure B of the present invention comprises a case C, an elastic terminal D, locking elements E, and an external circuit board F, wherein side edges of the case C include projection parts C1 which are provided with through-holes C2 corresponding to positioning slots F1 of the external circuit board F, and the through-holes C2 of projection parts C1 and the positioning slots F1 of external circuit board F are used by the locking elements E for locking; and the connector B is assembled by the case C, the elastic terminal D, and the locking element E, such that when the connector B is to be rigidly fixed on the external circuit board F, the connector B is locked with the external circuit board F, through a connection of locking parts El of the locking elements E to the positioning slots F1 of external circuit board F, thereby enabling the connector B to be rigidly assembled with the external circuit board F.

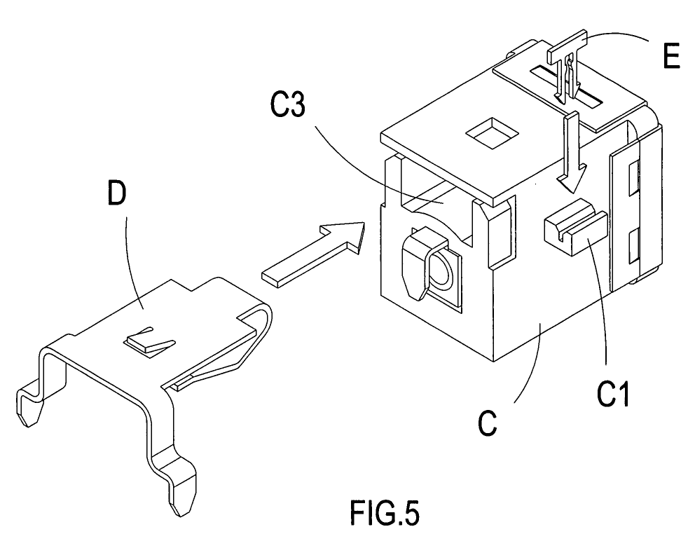

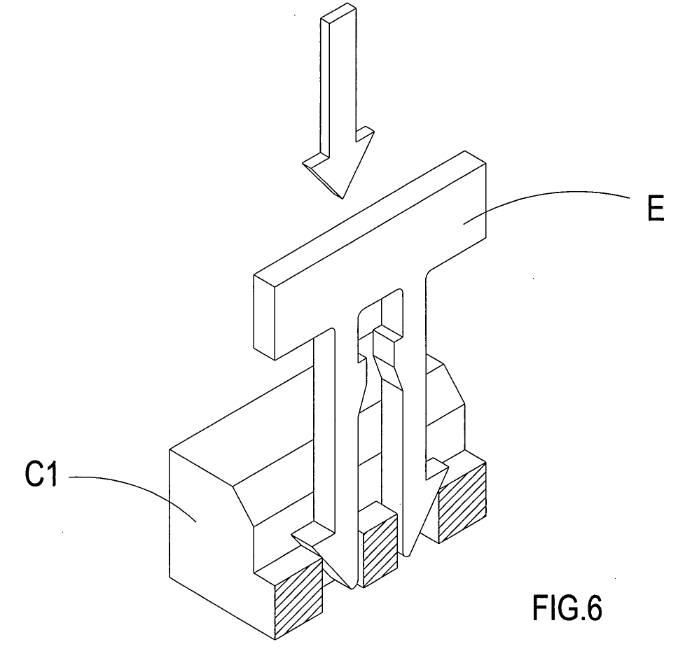

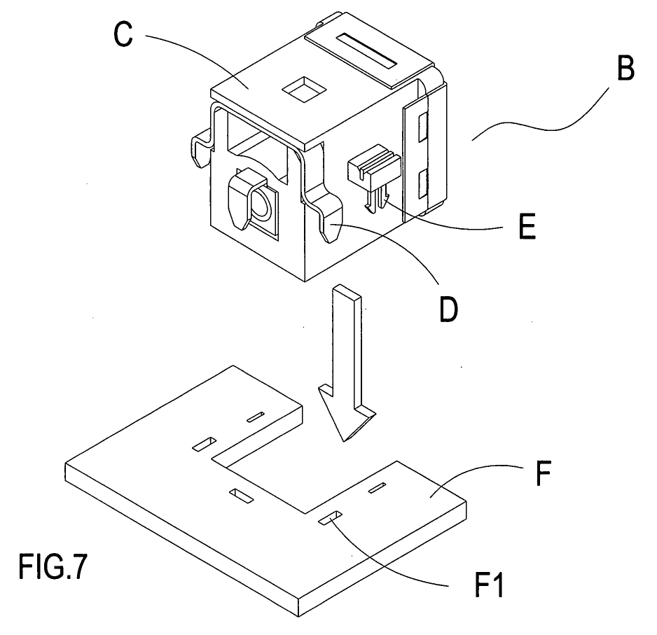

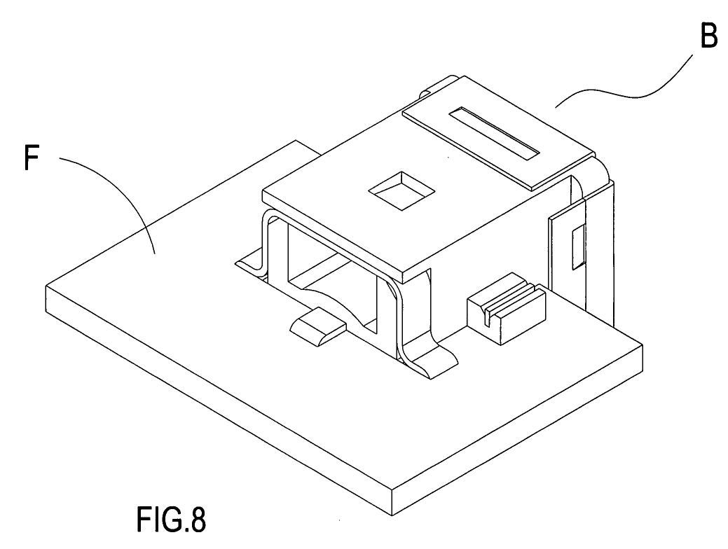

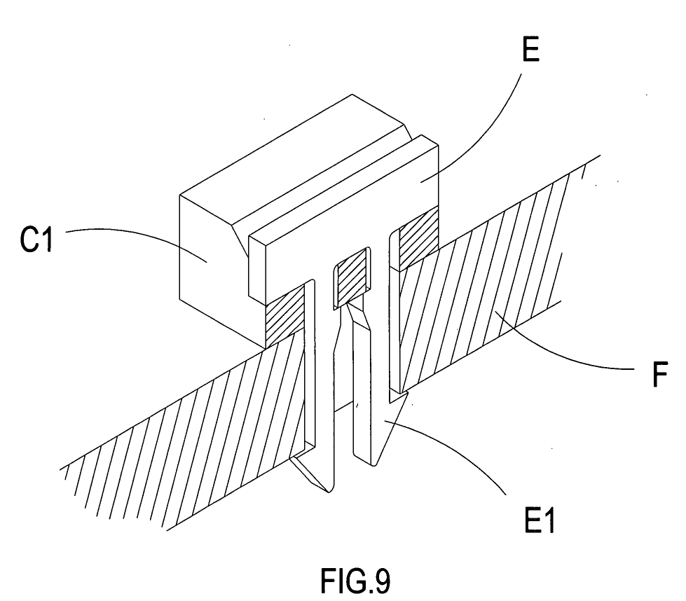

Referring to FIGS. 5 to 9, the present invention is to provide a connector structure B which is constituted by a case C, an elastic terminal D, locking elements E, and an external circuit board F, wherein the case C includes projection parts C1 which are provided with through-holes C2 corresponding to positioning slots F1 of the external circuit board F, and the through-holes C2 are used by the locking elements E for latching the connector B with the external circuit board F; the elastic terminal D includes assembly parts D1 which are corresponding to the positioning slots F1 of external circuit board F, such that the connector B can be positioned on the external circuit board F; the locking elements E include locking parts E1 which are corresponding to the through-holes C2 of projection parts C1, such that the connector B can be rigidly fixed on the external circuit board F; the external circuit board F includes the plural positioning slots F1 which provide for the positioning and the rigid fixation of connector B on the external circuit board F; and the connector B is assembled by the case C, the elastic terminal D, and the locking elements E. When the connector B is to be assembled with the external circuit board F, the elastic terminal D is placed into a holding space C3 of the case C, and then the locking elements E are placed into the projection parts C1 of case C, such that the case C, the elastic terminal D, and the locking elements E are assembled into the connector B. Next, the connector B is positioned on the external circuit board F, through the assembly parts D1 of elastic terminal D and the positioning slots F1 of external circuit board F. In a same time, the locking elements E which are locked with the connector B are connected to the connector B and the external circuit board F, through the locking parts E1 and the positioning slots F1 of external circuit board F, such that the connector B and the external circuit board F are rigidly assembled.

To further manifest the advancement and practicability of the present invention, the present invention is compared with a conventional connector as follow.

Shortcomings of a Conventional Connector
1. There are no positioning slots on the external circuit board.
2. According to item 1, it is more difficult to position the connector.
3. There are no elements to latch the connector with the external circuit board.
4. According to item 3, the connector is easy to get loosened or dropped off.

Advantages of the Present Invention
1. The external circuit board is provided with the positioning slots.
2. According to item 1, the connector can be easily positioned.
3. It is provided with the locking elements for latching the connector with the external circuit board.
4. According to item 1, the connector can be prevented from getting loosened or dropped off.
5. It has the advancement and practicability.
6. It can improve an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A connector structure being constituted by a case, an elastic terminal, locking elements, and an external circuit board, wherein side edges of the case are provided with projection parts having through-holes, such that the connector is latched with the external circuit board through the locking elements, thereby enabling the connector to be rigidly assembled with the external circuit board.

2. The connector structure according to claim 1, wherein the through-holes of projection parts are used by the locking elements for locking.

3. The connector structure according to claim 1, wherein the external circuit board is provided with positioning slots for positioning the connector.
